(19) United States
(12) Patent Application Publication
(10) Pub. No.: US 2005/0218655 A1
(43) Pub. Date: Oct. 6, 2005

(54) Duct board with adhesive coated shiplap tab

(75) Inventors: John O. Ruid, Schwenksville, PA (US); Murray S. Toas, Norristown, PA (US); David Lewis, Newton, NC (US)

Correspondence Address: DUANE MORRIS, LLP;IP DEPARTMENT, ONE LIBERTY PLACE, PHILADELPHIA, PA, 19103-7396, US

(73) Assignee: Certain Teed Corporation

(21) Appl. No.: 11/104,247

(22) Filed: Apr. 11, 2005

Related U.S. Application Data
(63) Continuation-in-part of application No. 10/817,342, filed on Apr. 2, 2004.
(63) Continuation-in-part of application No. 10/898,740, filed on Jul. 26, 2004.

(51) Int. Cl. F16L 3/00

(52) U.S. Cl. 285/915

(57) ABSTRACT

A duct board includes a sheet, facing having a tab and adhesive applied to the tab. The sheet of the duct board has an outer surface and includes a male shiplap edge. The facing is located on the outer surface of the sheet. The tab of the facing extends substantially over the width of the male shiplap edge. The adhesive is applied to an inner surface of the tab.

This application is a continuation in part of U.S. patent application Ser. No. 10/817,342, filed Apr. 2, 2004, and is a continuation in part of U.S. patent application Ser. No. 10/898,740, Jul. 26, 2004.

### FIELD OF THE INVENTION

The present invention relates to duct systems in general, and more specifically to apparatus for improving sealing between duct board segments.

### BACKGROUND OF THE INVENTION

The use of rigid fibrous glass ducts to supply and return air for residential and commercial heating, ventilating, and air conditioning systems is well known. The popularity of such duct systems has increased significantly during the past 25 years with millions of feet of fibrous glass duct work presently in operation in schools, shopping centers, office buildings, apartments, and residences throughout the United States. When compared to a traditional metal duct system, the use of a fibrous glass duct system can improve the overall quality of the indoor environment through its efficient thermal and acoustical properties, and its ability to virtually eliminate condensation problems. Moreover, a fiber glass duct system is generally less expensive to install than an insulated and sealed wrapped or lined sheet metal system because of faster and easier fabrication and installation. Fiber glass duct system also weigh less and therefore easier to handle as compared to sheet metal systems. Duct board can vary in thickness, but is commonly supplied in 1 inch and 1 ½ inch configurations.

Rigid fibrous glass ducts are fabricated from sheets of resin bonded inorganic glass fibers. Typically, on one major surface of the sheet (hereinafter called duct board) a facing is provided which serves as a finish and an air barrier/vapor retarder. The facing is typically a metal foil or a reinforced foil laminate. This facing ultimately serves as the outside surface of the assembled duct system.

The duct boards are fabricated by folding into square, rectangular, or multi-sided duct sections for use in both residential and commercial heating, ventilating, and air conditioning duct systems. The board is grooved at the fold lines and formed into duct sections, which are then stapled and sealed at the longitudinal seam. Sections are joined in the same way. Frequently, the duct boards are supplied with factory molded male and female shiplap edges to ensure tight and strong fabricated joints. In one commercially available configuration, the outside reinforced foil laminate air barrier extends over the full width of the male shiplap edges to serve as a sealing or stapling flap during fabrication. Duct boards are also commercially available without the shiplap edges in a butt edge configuration. Sealing of seams (formed by the joining of opposite edges of an individual duct board into one duct section) and joints (formed by the joining of two duct sections) is accomplished through the use of appropriate tapes. Such tapes include pressure-sensitive aluminum foil tapes and mastic and glass fabric tape systems. Typically, the seams are sealed by taping along longitudinal seam on the outer surface of the facing and the joints are sealed by taping around the outer surface of the facing where the duct sections meet. Heat activated adhesives have also been used as a tape used to seal seams.

FIG. 1 illustrates a typical duct system 10. The duct system 10 includes two duct sections 12, 14. The duct sections 12, 14 are secured together end-to-end at joint 16 with structural tape 18 wrapped around the outside of the duct sections. The ends of the duct sections can be formed into mating male and female shiplap edges or may be in a butt edge configuration.

While the use of fibrous glass duct boards to form duct systems has resulted in significant improvements in the fabrication, installation and performance of residential and commercial air handling systems, further improvement would be beneficial. For instance, it would be beneficial to reduce the time and labor involved in joining sections of ducts and to improve the seal between duct sections.

### SUMMARY OF THE INVENTION

Some embodiments provide a duct board including a mineral fiber duct board sheet having an outer surface and a male shiplap edge. A facing is located on the outer surface of the sheet and has a tab extending over the male shiplap edge, substantially along a length thereof. Adhesive is applied to an inner surface of the tab.

In other embodiments, a duct system comprises two or more duct sections. The duct sections each have a duct board comprising: a mineral fiber duct board sheet having a male shiplap edge, a female shiplap edge, an outer surface, and two opposing longitudinal edges joined together to form a hollow duct. A facing is located on the outer surface of the sheet and has a tab extending over the male shiplap edge substantially along a width thereof. Adhesive is applied to an inner surface of the tab. The male shiplap edge of a first duct section is joined to the female shiplap edge of a second duct section, and the adhesive applied to the tab of the facing of the first duct section adheres the tab to the female shiplap edge of the second duct section.

In some embodiments, a method for forming a duct section comprises applying adhesive to an inner surface of a tab of facing, wherein the tab extends over the a first longitudinal edge of a mineral fiber duct board substantially along a width thereof. said first longitudinal edge having a male shiplap form, and securing the adhesive to a second longitudinal edge of the duct board to form the duct section, wherein said second longitudinal edge has a female shiplap form.

Other details, objects and advantages of the present invention will become apparent as the following description of the presently preferred embodiments and presently preferred methods of practicing the invention proceeds.

### BRIEF DESCRIPTION OF THE DRAWINGS

FIG. 1 is an exploded view of a conventional duct system.

FIG. 2 is an isometric view of an exemplary duct board according to the invention.

FIG. 3. is a side elevation view of the duct board of FIG. 2.

FIG. 4 is an exploded view of a duct system including two of the duct boards shown in FIG. 2, folded to form duct sections.

FIG. 5 is a side elevation view of an alternative embodiment of a duct board according to the invention.

FIG. 6 is a side elevation view of a variation of the duct board of FIG. 3.

### DETAILED DESCRIPTION

U.S. patent application Ser. No. 10/817,342, filed Apr. 2, 2004, and U.S. patent application Ser. No. 10/898,740, Jul. 26, 2004 are both incorporated by reference herein in their entireties, as though fully set forth below.

This description of the preferred embodiments is intended to be read in connection with the accompanying drawings, which are to be considered part of the entire written description of this invention. In the description, relative terms such as “lower,” “upper,” “horizontal,” “vertical,”, “up,” “down,” “top” and “bottom” as well as derivative thereof (e.g., “horizontally,” “downwardly,” “upwardly,”etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

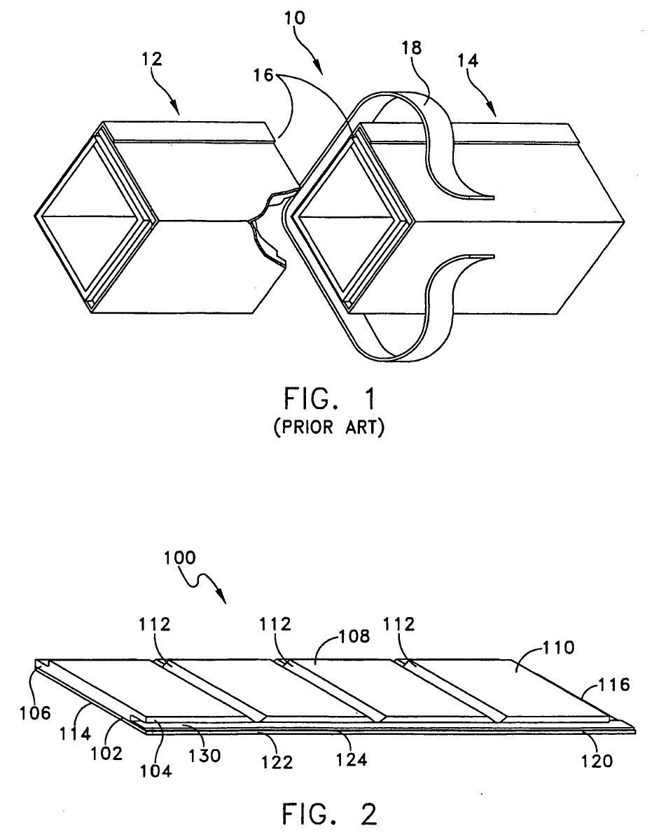

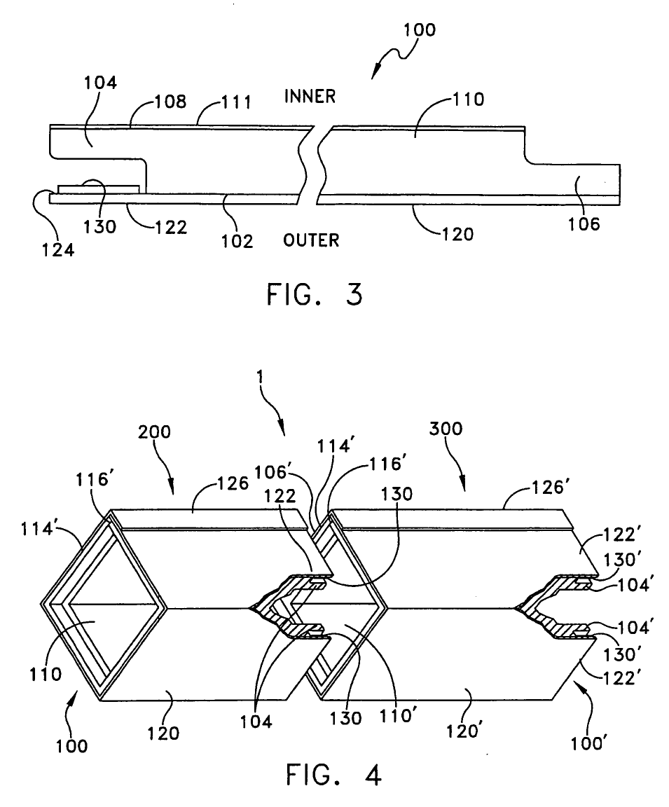

FIGS. 2 and 3 show an exemplary duct board, generally identified by reference numeral 100, constructed according to one embodiment of the present invention. Duct board 100 comprises a sheet 110, facing 120 and adhesive 130. The sheet 110 includes an outer surface 102, a male shiplap edge 104 and a female shiplap edge 106. The male edge 104 and female edge 106 are parallel to each other and comprise the lateral edges of sheet 110. Sheet 110 may be between 2.5 and 5.1 centimeters (1 to 2 inches), and is preferably between 2.5 and 3.75 centimeters (between one and 1.5 inches) thick and includes a fiber glass layer comprised of compressed fiber glass which provides the primary insulation, sound absorption, and structural strength of the duct board 100. Alternatively, sheet 110 may also be comprised of foam material, composite materials, plasterboard, cardboard, wood fiber board and/or drywall board or combinations thereof. Duct board 100 may also include a non-woven or woven facing 111 such as a mat (See FIG. 3) covering an inside surface 108 of the sheet 110. Such facing 111 would preferably be a glass nonwoven mat with an antimicrobial additive to resist mold growth.

The sheet 110 may be a mineral fiber duct board having a density from about 2 pounds per cubic foot (PCF) to about 8 PCF. Preferably, the density of the insulation board 110 is from about 2.5 PCF to about 4.0 PCF, and more preferably, the density may be about 3 PCF. An exemplary board material is a fiber glass material having a binder content from about 6% to about 17%, preferably from about 14% to about 15%. A water repellant may be mixed with the binder or injected into the binder before the binder is sprayed on to the fiber glass. Exemplary water repellents may be DC347, DC346, and DC 1581 from Dow Corning of Midland Mich. The water repellant may form a fraction of the total board content ranging from about 0.1% to about 2%. Some embodiments include about 0.2% water repellent. The water repellent may also be used to treat the facing 111 laminated to the board.

The hydrophobic agent is preferably introduced to the binder shortly before the spraying. The silicone may be added to the wash water used as dilution water shortly before spraying the fibers.

The silicone hydrophobic agent may also be applied to the mineral fibers separately from the binder in a water emulsion or solution that is used to cool the hot mineral fibers in a mineral fiber insulation fiberizing and forming section before the binder is applied.

Sheet 110 preferably also includes a series of grooves 112 that allow sheet 110 to be folded inwardly to form a hollow duct section 200, 300 (See FIG. 4). Grooves 112 are cut perpendicular to male shiplap edge 104 and female shiplap edge 106. Two longitudinal edges 114, 116 run the length of sheet 110 and meet at a seam when sheet 110 is folded to form a duct section 200, 300. Edges 114, 116 may be shiplap edges or may be butt edges. Sheet 110 can be cut into lengths, the length of which is determined by the desired width or diameter and the desired number of sides of the formed duct section. The cross-section of the duct section may be any shape, including square, rectangular or circular. A polygonal shape having a large number of flat sides can be formed to approximate a circle.

Male shiplap edge 104 and female shiplap edge 106 run the width of sheet 110. The width of sheet 110 is typically about 122 centimeters (4 feet) providing for 122 centimeter (four foot) duct sections. The shiplap edges 104, 106 are typically factory molded. Shiplap edges 104, 106 each form a perimeter of duct section 200, 300 when duct board 100 is folded to form a duct section and form a circumference when duct board 100 is formed in a circular duct.

A preferred method of forming the shiplap edges is described in U.S. patent application Ser. No. 10/817,342, filed Apr. 2, 2004, which is incorporated by reference. This method for forming a shiplap edge in a duct board comprises the steps of: molding a shiplap edge in a first duct board made of mineral fiber or mineral wool (the molded shiplap edge having a molded edge thickness), and machining the molded shiplap edge to a desired machined edge thickness that is less than the molded edge thickness.

Facing 120 is adhered to the outer surface 102 of sheet 110 and thus comprises the outside of duct board 100. Facing 120 is preferably foil-scrim-kraft layers (FSK). The foil layer may be aluminum foil of preferably between about 0.00127 and 0.0254 millimeters (between 0.00005 and 0.001 inch) thickness. The scrim layer may be tri-directional fiber glass yarn reinforcing, preferably with a four per inch measure in both the machine direction and the cross direction. The kraft layer may be a conventional natural kraft paper with, for example, a weight of about 30 lbs. per 3,000 square feet. An adhesive, preferably a water-based adhesive, may be used to adhere the facing 120 to sheet 110. The adhesive used to laminate the facing 120 to the fiber glass board 110 may be, for example, Henkel America Product No. 80-8273 hot melt adhesive or product number 50-0965MHV water base adhesive from Henkel of Elgin, Ill.

As shown in FIG. 3, the facing 120 extends substantially the width of the male shiplap edge 104 forming shiplap tab 122. An adhesive 130 is applied to the inner surface 124 of tab 122. Preferably, adhesive 130 covers substantially the entire inner surface 124 of tab 122. The facing 120 on the female shiplap edge 106 should extend to the edge, or very close to the edge. Thus, when a male shiplap edge 104 of one duct section 200 is mated with a female shiplap edge 106 of another duct section 300, the adhesive 130 adheres the shiplap tab 122 to the portion of the facing 120 covering the female shiplap edge 106 of a duct board sheet. This provides better adhesion than if the adhesive 130 contacts bare fiber glass. The adhesive 130 may be applied by a facing manufacturer or may be applied during duct board manufacture. The application of the adhesive 130 in this manner enables the assembly of duct sections to be performed easier and quicker, without the need for additional labor in the field of taping around the joint of the duct sections. It also allows for an improved seal and longer lasting seal over that of tape applied around the outside of the duct sections, which are subject to deterioration over time due to external conditions.

Adhesive 130 is preferably a pressure-sensitive tape, such or a heat activated adhesive. Where adhesive 130 is a pressure sensitive tape, the tape is preferably a double-faced tape having a release liner or release paper. Some suitable self sealing tapes—double sided tapes include, but are not limited to: Venture Tape 1163H NS and 1163/ms74 from Venture Tape of Rockland, Mass., and 3M 9500PC, 9490LE, 9690 from Minnesota Mining and Manufacturing Co. of St. Paul, Minn. The release liner would be pulled off just before the male and female shiplap edges of two duct sections were joined and the joint would be assembled with pressure. This is the preferred method where the adhesive is applied during duct board manufacture.

Where a heat activated adhesive is used, shiplap tab 122, having the adhesive applied to the inner surface 124, can be ironed onto the female shiplap edge of the adjoining duct section. The adhesive can be reactivated with the hot iron after the male and female shiplap edges of the two duct sections have been joined resulting in a secure seal. Other methods of applying heat may be used, such as by use of a heat gun, or application of radiant heat.

FIG. 4 shows a duct system 1 according to one embodiment of the present invention. The duct system 1 includes two or more duct sections 200, 300. Each duct section 200, 300 comprises a duct board 100, 100′ that has been folded to form a hollow duct by joining the two opposing longitudinal edges 114, 116, 114′, 116′. These longitudinal edges may be butt edges or may be shiplap edges, for example. Facing 120, 120′ may include a flap 126, 126′ that can be folded against the exterior surface of the duct section and taped or stapled, for example, to provide a rigid duct section.

The duct boards 100, 100′ include a sheet 110, 110′ having a male shiplap edge 104, 104′, a female shiplap edge 106, 106′ and an outer surface 102, 102′. Facing 120, 120′ is located on the outer surface 102 (See FIG. 3) of the sheet 110, 110′ and includes a shiplap tab 122, 122′ which extends substantially over the width of the male shiplap edge. Adhesive 130, 130′ is applied to an inner surface of the tab 122, 122′. The adhesive securely joins the male shiplap edge 104 of duct section 200 to the female shiplap edge 106′ of duct section 300.

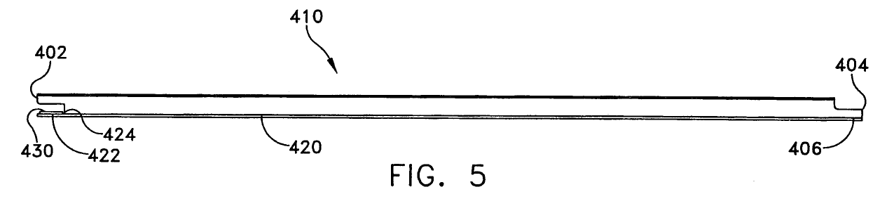

As described above, adhesive 130 can be used on the inner surface 124 of the facing 120 which extends along the width of the male shiplap edge 104 on the lateral edges of the duct board sheet 110 for the purpose of securing together two adjacent sections of duct. As shown in FIG. 5, adhesive may also be applied in the same manner for the purpose of securing together the two longitudinal edges 402, 404 of the duct board sheet 410 to form an individual duct section. In this embodiment, the two longitudinal edges 402, 404 would include one longitudinal edge 402 having a male shiplap form and one longitudinal edge 404 having a female shiplap form. Adhesive 430 is applied to the inner surface 424 of a tab 422 of a facing 420, the tab 422 extending the width of the longitudinal edge 402 having the male shiplap form. When the sheet 410 is folded to form a duct section, the tab 422 would be adhered to the outer surface 406 of the longitudinal edge 404 having the female shiplap form to securely seal the duct section.

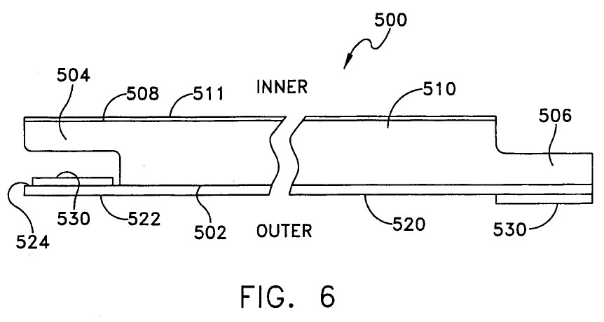

FIG. 6 shows a duct board 500 with is a variation of the embodiment shown in FIG. 3, in which adhesive 530 is applied to the outer surface of the FSK facing 520 at the edge of the female shiplap edge 506. This adhesive on the outer surface of the facing 520 at the edge of the female shiplap edge may be in addition to, or in place of, the adhesive 530 on the inner surface 524 of the tab 522 overlying the male shiplap edge 504. The other elements of FIG. 6, including sheet 510, outer surface 502, inside surface 508 and mat facing 511, are the same or similar to the respective items 110, 102, 108 and 111 of FIG. 3.

The nonwoven or woven facing 111 can be white or black. An example of a preferred white material for the non-woven mat facing 111 is “Dura-Glass®” R8940 wet laid glass non-woven mat, manufactured by Johns Manville ofDenver, Colo. The exemplary non-woven mat facing 111 has a thickness of about 0.023 centimeter (0.009 inch) and has a mass per unit area of about 38.7 grams/meter². Another example is a wet laid fiber glass and polyester fiber non-woven mat with a latex binder and having a thickness of, for example, 0.03 centimeter (0.012 inch), and a weight/square of 70 grams/m².

An exemplary water repellent glass nonwoven may be Manniglas 1807 nonwoven from Lydall, Inc. of Manchester, Conn., weighing about 0.8 pounds per 100 square feet. Other suitable nonwovens may weigh up to about 2 pounds per 100 sq. ft.

Other exemplary facings may include 40# Manniglass 1886 Black mat or 1786 Black mat from Lydall Inc. of Green Island, N.Y. or water repellant Elasti-Glass® 3220B mat from Johns Manville of Denver, Colo. In other embodiments, the facing 111 is formed from filament glass fibers in an acrylic-based binder, such as Johns Manville Dura-Glass® 8440 with a water repellant (e.g., silicone or fluorocarbon) applied thereto. Other mat materials providing similar or better degrees of water repellency may alternatively be used. For example, such materials may include non-woven mats of glass fibers randomly dispersed into a web in a wet-laid process, bound in an acrylic or other resin system, and post treated with a fluorocarbon based coating that provides the desired degree of water repellency.

In one embodiment, the facing 111 comprises a nonwoven fiber glass mat having weight of less than 1.1 lb/100 ft² (53.7 g/m²), and more preferably less than 1.0 lb/100 ft² (48.81 g/m²). In one exemplary embodiment, the nonwoven fiber glass mat is the 27# Manniglas® 1807 mat having a target weight of 0.87 lb/100 ft² (42.3 g/m²) and maximum weight of 0.97 lb/100 ft² (47.5 g/m²) available from Lydall Inc., the 23# Manniglas® 1803WHB mat having a target weight of 0.80 lb/100 ft² (39.1 g/m²) and a maximum weight of 0.90 lb/100 ft² (43.9 g/m²) also available from Lydall Inc. or a mat having a weight therebetween. These exemplary nonwovens include an integral water repellent. In an exemplary embodiment, the nonwoven is combined, such as by saturation, with a water repellent comprising a fluorinated polymer, such as an fluorinated acrylic, fluropolymer or fluorocarbon, silicone, wax, oil, wax-asphalt emulsions, acrylics, other emulsions, latexes, polyvinyl acetates, etc. The weights reflect the combined weight of the coating and mat. In this embodiment, the desired water repellency can be achieved without the use of a water repellent added to the binder of the insulation board or adhesive used to adhere the nonwoven to the duct board.

Alternatively, interior facing 111 may be a woven fabric. Exemplary woven glass fabrics may be a square pattern with 10×10 yarns per inch such as PermaGlas-Mesh Resin Coated Fiber Glass Fabric 10×10, or PermaGlas-Mesh Resin Coated Woven Glass Fabric 20×20, manufactured by Saint-Gobain Technical Fabrics of St. Catharines, Ontario, Canada. Both fabrics have a tensile strength of 85 pounds per inch width in the machine direction (MD) and cross direction (CD). Alternatively, Childers CHIL-GLAS #10 Glass Fiber Reinforcing Mesh or Carolina Narrow Fabric woven glass may be used.

Needled, woven, knitted and composite materials may also be used, because of their impressive strength-to-weight ratio. The interior facing 111 can contain fibers and filaments of organic and inorganic materials. Examples include fibers containing glass, olefin (such as polyethylene, polystyrene and polypropylene), Kevlar®, graphite, rayon, polyester, carbon, ceramic fibers, or combinations thereof, such as glass-polyester blends or Twintex® glass-olefin composite, available from St. Gobain Corporation, France. Of these types of fibers and filaments, glass compositions are desirable for their fire resistance, low cost and high mechanical strength properties. The four main glasses used are high alkali (A-glass or AR-glass) useful in motor or cement applications, such as in tile backing, electrical grade (E-glass), a modified E-glass that is chemically resistant (ECR-glass), and high strength (S-glass).

The resistance (to liquid water) of the interior surface may come from the lamination process of a non liquid water resistant fabric laminated to a water resistant mineral fiber board with an adhesive having a hydrophobic additive. The resultant laminated board surface is resistant to liquid water even though the fabric itself may or may not be liquid water resistant. For example, if a fabric 111 having a loose, open weave (e.g., 10×10) is used, the spaces between the fibers of the fabric 111 are open, and the resistance to water penetration of the insulation surface with the adhesive and fabric thereon would be provided by the resistance of the insulation and/or the resistance of the adhesive to penetration by liquid water.

Combinations of fiberglass mat, scrim, chopped fibers and woven or knit filaments or roving can also be used for the interior facing layer 111. The appropriate weights of fiberglass mat (usually chopped-strand mat) and woven roving filaments or loose chopped fibers are either bound together with a chemical binder or mechanically knit, needled felted or stitched together. One suitable combination would be a fiberglass and/or resin fiber mat or scrim layered with chopped glass or resin fibers and then needled, felted or stitched together to decrease porosity.

The interior facing 111 may be, for example, a non-woven material, a glass and/or a polymer fabric. The facing 111 may optionally be water repellant.

Although the invention has been described in terms of exemplary embodiments, it is not limited thereto. Rather, the appended claims should be construed broadly, to include other variants and embodiments of the invention that may be made by those skilled in the art without departing from the scope and range of equivalents of the invention.

1. A duct board comprising:
a mineral fiber duct board sheet having an outer surface and a male shiplap edge;
a facing located on the outer surface of the sheet and having a tab extending over the male shiplap edge, substantially along a length thereof; and
adhesive applied to an inner surface of the tab.

2. The duct board of claim 1 further comprising a female shiplap edge, wherein the facing covers the female shiplap edge.

3. The duct board of claim 2, wherein the male and female shiplap edges are lateral edges of the duct board, said lateral edges each forming a perimeter of a duct section when the duct board is folded to construct the duct section.

4. The duct board of claim 2, wherein the male and female shiplap edges are longitudinal edges of the duct board, wherein said longitudinal edges are capable of mating together to form a single duct section.

5. The duct board of claim 2, further comprising adhesive applied to a portion of the facing covering the female shiplap edge.

6. The duct board of claim 1, wherein the adhesive is a heat activated adhesive.

7. The duct board of claim 1, wherein the adhesive is a pressure sensitive adhesive.

8. The duct board of claim 7, wherein the pressure sensitive adhesive has a release liner.

9. The duct board of claim 7, wherein the pressure sensitive adhesive is a double-faced tape.

10. A duct system comprising two or more duct sections, said duct sections each comprising a duct board comprising:
a mineral fiber duct board sheet having a male shiplap edge, a female shiplap edge, an outer surface, and two opposing longitudinal edges joined together to form a hollow duct;
facing located on the outer surface of the sheet and having a tab extending over the male shiplap edge substantially along a width thereof; and
adhesive applied to an inner surface of the tab;
wherein the male shiplap edge of a first duct section is joined to the female shiplap edge of a second duct section, and wherein the adhesive applied to the tab of the facing of the first duct section adheres the tab to the female shiplap edge of the second duct section.

11. The duct system of claim 10, wherein the first duct section and the second duct section are formed from respective first and second duct boards that are substantially identical to each other.

12. A duct system comprising two or more duct sections, said duct sections each comprising a duct board comprising:
a mineral fiber duct board sheet having a male shiplap edge, a female shiplap edge, an outer surface, and two opposing longitudinal edges joined together to form a hollow duct;
facing located on the outer surface of the sheet and having a tab extending over the male shiplap edge substantially along a width thereof; and
adhesive applied to an outer surface of the female shiplap edge;
wherein the male shiplap edge of a first duct section is joined to the female shiplap edge of a second duct section, and wherein the adhesive applied to the female shiplap edge of the second duct section adheres the female shiplap edge to the tab of the facing of the first duct section.

13. A method of forming a duct system comprising:
applying adhesive to an inner surface of a tab of facing, wherein the tab extends over a male shiplap edge of a first mineral fiber duct board, substantially along a width thereof, the first duct board being shaped to form a first duct section, and wherein the facing is located on an outer surface of the first duct board; and
securing the adhesive to a female shiplap edge of a second duct board shaped to form a second duct section.

14. The method of claim 13, wherein the adhesive is a heat activated adhesive, and the step of securing the adhesive to the female shiplap edge includes heating the tab.

15. The method of claim 13, wherein the adhesive is a pressure sensitive adhesive having a release liner, and wherein the release liner is removed prior to securing the adhesive to the female shiplap edge, and wherein the step of securing the adhesive includes applying pressure to a joint connecting the first and second duct sections.

16. A method of forming a duct section comprising:
applying adhesive to an inner surface of a tab of facing, wherein the tab extends over the a first longitudinal edge of a mineral fiber duct board substantially along a width thereof, said first longitudinal edge having a male shiplap form, and
securing the adhesive to a second longitudinal edge of the duct board to form the duct section, wherein said second longitudinal edge has a female shiplap form.
